(19) United States
(12) Patent Application Publication
(10) Pub. No.: US 2007/0005623 A1
(43) Pub. Date: Jan. 4, 2007

(54) Process oriented message driven workflow programming model

(75) Inventors: Joseph L. Self, Redmond, WA (US); Craig T. Sinclair, Sammamish, WA (US); Gregory D. Fee, Seattle, WA (US); Marcelo Uemura, Seattle, WA (US); William Devlin, Sammamish, WA (US); Pravin Indurkar, Sammamish, WA (US); David Bozich, Enumclaw, WA (US); Tracey G. Trewin, Woodinville, WA (US); Jayesh Rege, Redmond, WA (US); Gregory A. Eisenberg, Woodinville, WA (US); Jeanine E. Spence, Seattle, WA (US); Wilf G. Russell, Redmond, WA (US); James L. Waletzky, Snoqualmie, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/171,050

(22) Filed: Jun. 30, 2005

(51) Int. Cl. G06F 7/00

(52) U.S. Cl. 707/101

(57) ABSTRACT

The present application describes a framework for a process oriented message driven workflow programming model where a complex process can be modeled by breaking down the complex process into a coarse grained series of atomic processes that interact through messages. A process is represented as a data structure that includes typed properties and one or more actions. The typed properties are used to associate a process with an incoming message, and the actions are steps that are executed when certain conditions are met by message properties and process data structure properties. A process action may add one or more properties to the process and/or modify an existing property. Processes are invoked and communicate solely through messages. When a process is executed, results of the execution are communicated to one or more other processes or external applications with messages that include any new and/or modified properties.

### BACKGROUND

In modern working environments, people are typically in a position where they are involved with some sort of business process that is carried out to achieve an enterprise goal. Many business processes involve at least some level of automation, whether it is a purchase order system, an accounting system, or the like.

System architects that design automated systems that require some level of human interaction typically use constructs (e.g. transactional boundaries) to ensure consistency within the systems. Even so, such systems typically have routines that exist in an intermediary stage, i.e. routines that make calls to other routines and wait for a response. When a system crashes, such inconsistencies increase the effort required to recover the system.

### SUMMARY

The present disclosure describes a framework for a process oriented message driven workflow programming model where a complex process can be modeled by breaking down the complex process into a coarse grained series of processes that interact through messages. Each process that makes up a part of the complex process is created as a separate, task-based unit that is always in consistent state.

A process is represented as a data structure that includes typed properties and one or more actions. The typed properties are used to associate a process with an incoming message, and the actions are steps that are executed when certain conditions are met. Among other things, a process action may add one or more properties to the process or modify an existing property. Processes are invoked and communicate solely through messages. When a process is executed, results of the execution are communicated to one or more other processes or external applications with messages.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an exemplary data structure that is used to define a process.

FIG. 2 is a block diagram of an exemplary system in accordance with the present description.

FIG. 3 is a flow diagram depicting an exemplary methodological implementation of process handling.

FIG. 4 is a flow diagram depicting an exemplary methodological implementation of an action selection and execution process.

FIG. 5 is a block diagram depicting an exemplary general purpose computing device that may be used in conjunction with one or more implementations described herein.

### DETAILED DESCRIPTION

Overview

The presently described subject matter provides a framework for a process oriented message driven workflow programming model. The framework describes tools that may be used by a system architect, designer, modeler, etc. to automate a process with a system that is stable and consistent, i.e. that can be recovered from a system interruption event without a significant amount of resource involvement.

The model presented herein removes the need for the architect to directly use constructs (e.g. transactional boundaries) within a system. As described herein, systems comprise multiple processes that each represents a system task. For example, in a purchase order system, one task may be a process to validate a purchase order, while another task may be a process to create a purchase order. Among other things, processes include one or more executable actions that are executed when specified conditions are satisfied.

Each process is always in a consistent state, although all processes do not have to be consistent with each other. Additionally, the actions in a process are atomic, i.e. either all action instructions are executed or none are executed. As a result, a system designer does not need to include handlers for intermediate states such as, for example, that a mail message was constructed but not sent. Since there are no inconsistent states, a query to the system will return processes that are in a consistent state.

The processes of the framework described herein communicate via messages. For example, if a purchase order process requires a purchase order to be validated, a message will be designated for a purchase order validation process. When the purchase order validation process is complete, the process will generate an outbound message to communicate the result of its processing.

The present model has several advantages over a model that utilizes a prescriptive language, such as C#, C++, etc. Among other things, with a prescriptive language, objects call other objects and, therefore, a calling object must be aware of a called object. Also, a called object must be in an appropriate state in which it can receive a call.

These types of issues arise with stack-based languages because they are well structured and fully defined. In the model described herein, there is no stack. A system based on the present model is more responsive to ad hoc events that arise in human workflow situations.

Another advantage is that when a system crash occurs in a prescriptive language model, the system is not in a stable state. An administrator has to restart the system and backtrack to restore the system to a stable state. In the model described herein, the system is in a stable state if it happens to crash. Therefore, less work is needed to restore the system and resume processing.

In the following discussion, features of the described framework are discussed relative to a particular example. The example deals with a purchase order system. In this particular example, it is assumed that a purchase order is requested by a person or a process in an entity and is received by an exemplary system. In the exemplary system, the purchase order is created (or modified if it already exists), validated, approved, and sent to an appropriate supplier.

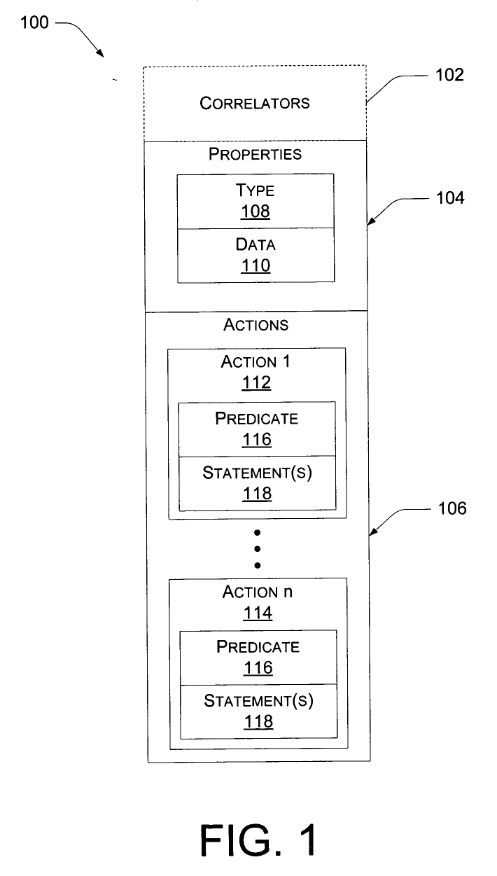

Furthermore, the following discussion deals with the terms “process” and “message”. The structure of a process is described, below, in relation to FIG. 1. Messages are related to processes in that they include similar properties. A process communicates with other processes via messages. Generally, when a process creates a message, the properties (and correlators if applicable) of the process are copied to the message. When a receiving process receives the message, the properties (and correlators if applicable) are copied into the process. These procedures are discussed in greater detail below.

An exemplary eXstensible Schema Definition (XSD) is appended hereto as “Appendix A” as an example how process instances may be defined.

Exemplary Data Structure

FIG. 1 is a block diagram of an exemplary process data structure 100 that is used to define a process. The exemplary process data structure 100 includes one or more correlators 102, one or more properties 104 and one or more actions 106.

In practice, process data structure 100 may be implemented without the correlators 102. Correlators 102 are used to match incoming messages to relevant processes. However, some implementations may not require such matching if all incoming messages are to be directed toward a particular process for example. Also, other correlation techniques may be implemented that may not require the correlators 102 in the process data structure 100. Therefore, the present discussion will not discuss any particular implementation of correlators and a correlation process. An example of the correlation process may be found in U.S. patent application Ser. No. 11/______, filed Jun. ______, 2005 by one or more of the present Applicants and assigned to Microsoft Corp., the assignee of the present application.

The properties 104 include a type 108 and data 110. A type 108 identifies a category of process that is represented by the data structure 100. One example of a type 108 is “Purchase Order”. Examples of data 110 include “Company Name”, “Reference Number” and/or other line items that may be required in a business process. The data 110 may include any data that a process may require to carry out the functionality required within a particular system.

Properties are dynamic, meaning that a process may add to or modify the properties 104 as a part of its function. For example, a “Validate Purchase Order” process will receive a message containing certain properties 104. After performing a validation routine, the “Validate Purchase Order” process may add a “PO Valid” or “PO Invalid” property to the properties 104 and include these properties in a resulting outbound message. This added property may be utilized to route the outbound message to another process.

The exemplary process data structure 100 also includes “Action 1” 112 through “Action n” 114. Virtually any number of actions 106 may be included in a process data structure 100. An action may include a predicate 116 and one or more executable statements 118. The predicate 116 is used to test for one or more particular conditions that are prerequisite to executing the statements 118. In one or more implementations, a predicate may not be required, e.g. if the actions are to be executed for any message received by the process. In one sense, even such a situation would include a predicate to the effect of “if a message is received, execute action(s)”.

Multiple actions 106 may be included but none to all of the actions may be executed in any particular situation, depending on whether an action predicate is satisfied. For example, a “Send Purchase Order” process may include a first action that has a predicate “if a message is received that is of type ‘Purchase Order’ and meets criteria X and Y, create and send a message to “Vendor A”. The “Send Purchase Order” process may also include a second action that has a predicate “if a message is received that is of type ‘Purchase Order’ and meets criterion Z, create and send a message to “Vendor B”.

An action 106 may add or modify a property 104 of the process data structure 100. For example, an action may be used to validate a purchase order and, upon validation, add a “Valid” property to the process data structure. An action may also add an action 106 to or modify an action 106 of the process data structure 100.

To ensure consistency of a system, actions 106 may be implemented entirely within the process data structure 100 so that no external calls are made from the process data structure 100. Actions may be implemented to make external calls and/or to spawn executable instructions. If external calls by actions are allowed in a particular implementation, then the calls are bounded by a process state. If the call never returns, aborts or malfunctions then the process data structure never progresses from its previous state. This way, successful execution of the actions either occurs and the process data structure progresses to a next consistent state or execution of the actions was unsuccessful and the process remains in its previous consistent state.

The elements shown in FIG. 1 are described in greater detail below, with respect to subsequent figures and/or examples.

Exemplary Workflow System

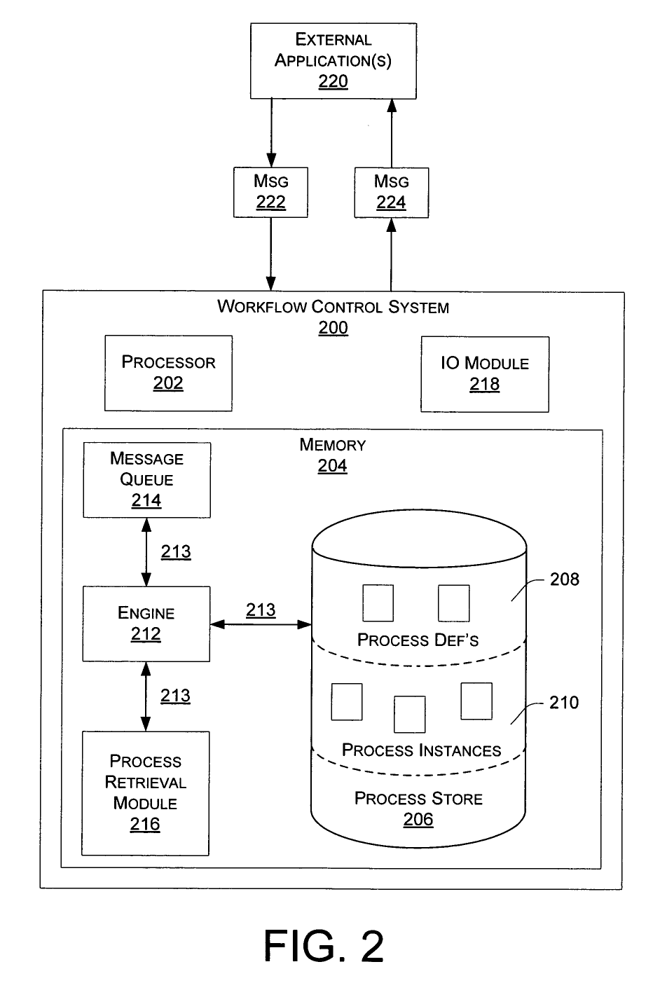

FIG. 2 is a block diagram of an exemplary workflow control system 200 in accordance with the present description. Although the exemplary workflow control system 200 includes various elements arranged in a particular manner and more or less particular functionality is attributed to the various elements below, it is noted that a system in accordance with the present description may have more or fewer and/or different elements, which may be distributed in a different arrangement than is shown herein. In addition, similar elements in one or more other implementations of a system in accordance with the present description may have functions similar but not identical to those described below, and said functions may be distributed differently among the different elements without departing from the scope of the subject matter claimed herein.

The exemplary workflow control system 200 includes a processor 202 and memory 204. The memory 204 includes a process store 206 that stores process definition data structures 208 and process instance data structures 210. Process definition data structures 208 serve as templates for creation of process instance data structures 210.

The exemplary workflow control system 200 also includes an engine 212, a message queue 214 and a process retrieval module 216. The engine 212 controls the inter-element operations of the workflow control system 200. Among other things that will be apparent in the following examples, the engine 212 retrieves messages 213 from the message queue 214 to be claimed by one or more relevant processes via the process retrieval module 216.

The engine 212 manages a plurality of threads and handles exceptions within the workflow control system 200. A thread is dispatched to retrieve a message 213 from the queue and proceeds to execute a process associated with the message 213. If a problem occurs, the engine 212 is responsible for taking appropriate action with the error generated and with the message 213 that caused the exception. In the event of such an exception, changes that may have been made to a process are discarded so that the process state remains as it was prior to being processed in accordance with the message/thread.

The message queue 214 maintains a list of messages 213 to be processed. There can be one or more message queues 214. When a message 213 is taken from the message queue 214, it is sent to a relevant process instance 210. When the process instance 210 is committed, the message 213 can be permanently removed from the message queue 214.

The process retrieval module 216 is configured to, inter alia, receive messages 213 from the engine 212 and select one or more relevant process instance 210 from the process store 206. This selection is made based on properties contained in the message 213. In at least one implementation, correlators contained in a message 213 are compared with correlators 102 included in process instances 210 to select one or more processes.

There will be zero to n number of process instances 210 returned. If more than one matching process instance 210 is found, then a predefined selection process is performed by the process retrieval module 216 to find a best match. If there is no matching process instance 210, then a process instance 210 is created from a process definition 208.

The workflow control system 200 also includes an input/output (IO) module 218 that is configured to receive inbound messages 222 from and send outbound messages 224 to one or more external applications 220. An external application 220 is any program that is not included in the workflow management system 200. External applications include but are not limited to, databases, mail servers, accounting systems, services, networks, devices or any other program that can be configured to generate a message that can be transmitted outside of that program for use in the workflow control system 200.

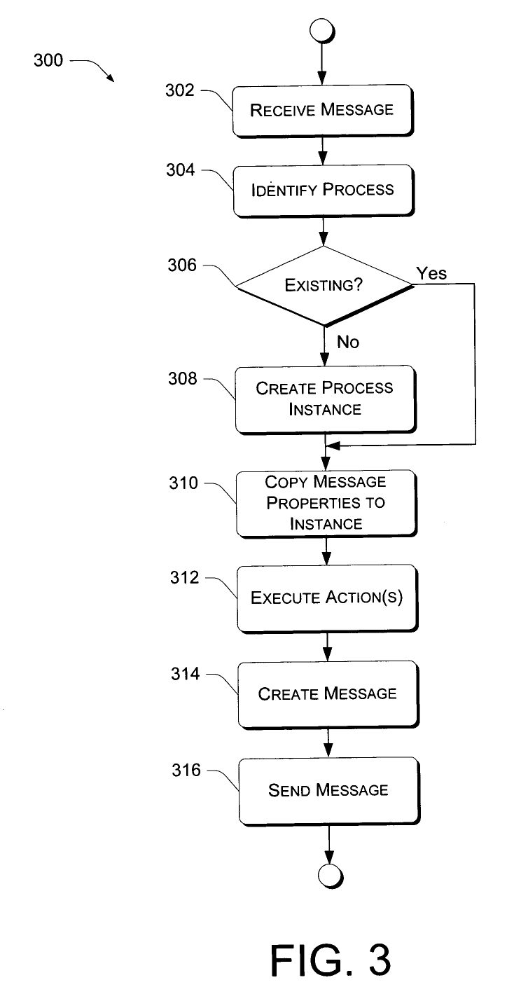

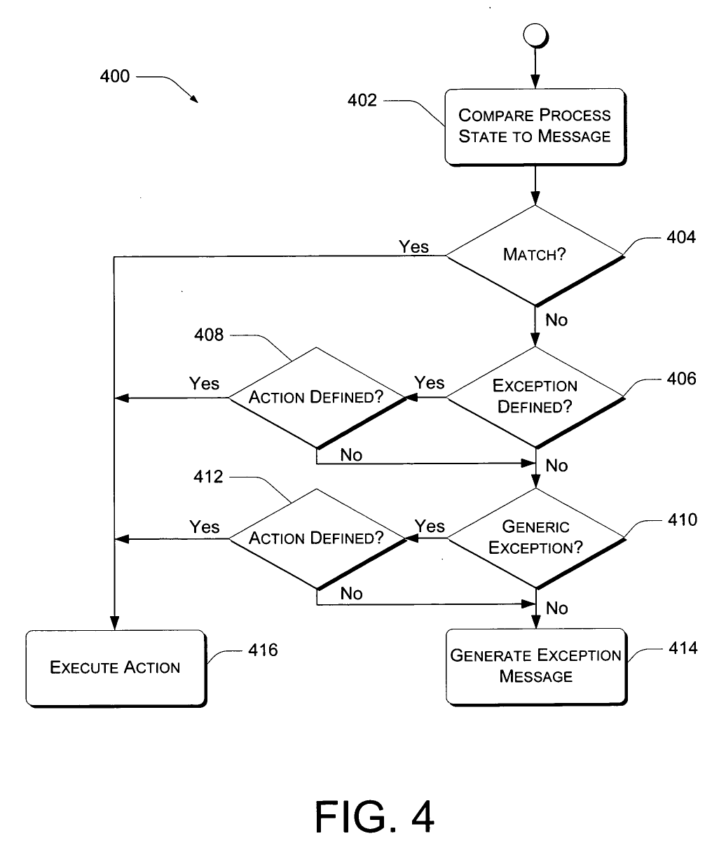

Further details of the workflow control system 200 will be described below, with respect to the flow diagrams shown in FIG. 3 and FIG. 4.

Exemplary Methodological Implementation: Process Handling

FIG. 3 is a flow diagram 300 depicting an exemplary methodological implementation of process handling. In the following discussion, continuing reference may be made to elements and reference numeral shown in previous figures. It is noted that the steps presented in the following exemplary methodological implementation may be performed alone or in conjunction with one or more other steps and that the steps may not necessarily be performed in the particular order shown below.

As previously noted, the example followed herein includes a system that performs steps of creating a purchase order, validating the purchase order, authorizing the purchase order, and sending the purchase order to an appropriate entity. Therefore, such a system—under the model described herein—has a “Create Purchase Order” process (i.e. process definition 208), a “Validate Purchase Order” process, an “Authorize Purchase Order” process, and a “Send Purchase Order” process. These processes will be described in following examples.

At block 300, the IO module 218 of the workflow control system 200 receives a message from the external application 220 and adds the message to the message queue 214. The message includes one or more properties, such as, for example, “Type=Purchase Order”, “Company Name=Joe's Office Supply”, “Item Name=Faber #2 Pencils”, etc.

At some point, the engine 212 retrieves the message from the message queue 212 and initiates a thread for the message. The message (thread) is handed to the process retrieval module 216 so that a process corresponding to the message may be identified (block 304). If no process is found (“No” branch, block 306), then the message properties are used to identify a process definition 208 that correlates to the message. The process definition 208 is copied to create a process instance 210 related to the message and the message properties are copied onto the process instance 210.

In the previously introduced example, suppose that the incoming message includes a “Type=Purchase Order” property but there is no property identifying a specific purchase order, such as a purchase order number. In the continuing example, the “Create Purchase Order” process will be identified by the process retrieval module 216 by some method at this point by, for example, being configured to correlate a message having a “Type=Purchase Order” property but no purchase order number property with the “Create Purchase Order” process.

In one or more other implementations, the process retrieval module 216 may attempt to match the message to a process and determine that no process can be correlated to the message. As a result, the process retrieval module 216 knows to then match the message with a process definition 208 to create a new process instance 210.

The “Create Purchase Order” process will have one or more actions 106 associated therewith. Here, it is assumed that there is an action that includes executable instructions that, when executed, create a process instance 210 corresponding to the message at block 308 by copying an appropriate process definition 208 to a new process instance 210.

If, on the other hand, a process instance 210 already exists that matches the message, block 308 is not performed. This would happen, for example, if the message contained a “Purchase Order Number” field identifying a particular purchase order. If a process instance 210 already existed for that purchase order, then no new process instance would need to be created.

At block 310, the message properties are copied to the process instance 210. In the example given, new properties are created for the process instance 210 (“Type=Purchase Order”, “Company Name=Joe's Office Supply”, “Item Name=Faber #2 Pencils”). If there had already been an existing purchase order (e.g. using a “Modify Purchase Order” process), then these new properties would be added to the present properties of the process instance.

After the process instance 210 is created, an initialization action may be performed that allows a system designer to set specific state and send out messages. The messages are not delivered until the implicit transaction is committed.

At block 312, the actions 106 included in the process instance 210 are executed. The engine 212 controls the execution, which takes place on the processor 202. The particular execution is accomplished using the properties on the message combined with the state properties of the process instance. The actions are executed via keys (e.g. “if X, then do Y”) with reference to the message and the process instance properties. Because the actions are selected via one or more keys, the order specified in the process definition does not indicate the order in which they will be executed.

Actions 106 include one or more executable statements 118 that specify one or more tasks to be accomplished by the action. The statements 118 are performed in an order specified in the action 106. If a predicate 116 is included in the action 106, then the statements 118 are only executed if and when the predicate 116 is satisfied.

Actions 106 can set a state in the process instance (i.e. add/modify a property of a process instance), create a new message, set properties on a message, send messages and collect responses. An example of a process instance setting a state in a process instance is when the “Validate Purchase Order” process first described above validates a purchase order. Upon validation, an action in the process will add a “PO Valid” property to the process instance. The “PO Valid” property will be included with messages sent from the process instance as described below.

Block 312 and the action execution process are described in greater detail below, with reference to FIG. 4.

When the actions 106 have been executed, a process instance 210 creates one or more outbound messages (block 314). At this time, all outbound messages and the inbound message are all committed. If an exception has been encountered (see FIG. 4, below), then nothing is committed. Objectively, it always appears as if the inbound message was either processed or not.

At block 316, the outbound message(s) is(are) sent from the process instance 210 to the engine 212. The engine 212 adds the message(s) to the message queue 214. The process repeats for each message removed from the message queue 214 by the engine 212.

Exemplary Methodological Implementation: Action Selection and Execution

FIG. 4 is a flow diagram 400 that depicts an exemplary action selection and execution process in accordance with the present description. The flow diagram 400 is a more detailed description of block 312 from FIG. 3 (“Execute Actions”). In the following discussion, continuing reference may be made to elements and reference numeral shown in previous figures. It is noted that the steps presented in the following exemplary methodological implementation may be performed alone or in conjunction with one or more other steps and that the steps may not necessarily be performed in the particular order shown below.

At block 402, the process state (i.e. the properties of the process instance 210) is compared to the message. The process state has properties defined that are maintained for the life of the process. The life span of a process instance can be a very long period of time (months or years). When a process instance is not processing a message it is stored and, therefore, requires no space in a runtime environment.

Properties have types, names and in some cases a value. The type can either be a well known primitive type, a hard type (e.g. a CLR (Common Language Runtime) runtime type) or it can be a declarative type defined in a protocol such as SOAP (Simple Object Access Protocol).

When a message arrives, process instance actions are evaluated (i.e. using the predicate 116 of the action 112) and if their logical equation evaluates to “True” (“Yes” branch, block 404) then the action is executed at block 416. If no action predicate evaluates to “True” (“No” branch, block 404), then the properties of the process instance are used in an attempt to find an exception block for this particular state.

An exception block is one or more actions 106 that are executed in the event that no action predicate appearing prior to the execution block is satisfied. Particular exceptions may be defined in exception blocks of actions but they are not defined in all cases. Particular exceptions are exceptions that satisfy an exception predicate based on message/process properties, e.g. “if no action satisfied and ‘company=Joe's Office Supply’, then send message toJoe.”

In contrast, generic exceptions may be included in an exception block. A generic exception is an exception that occurs merely when no action predicate appearing prior to the execution block is satisfied. Message/process properties are not relevant to a generic exception.

If there is an exception block that is defined for a particular exception (“Yes” branch, block 406) and an action is defined for the particular exception (“Yes” branch, block 408), then the defined action is executed at block 416. If no exception is defined (“No” branch, block 406) or if an exception is defined but there is no action defined (“No” branch, block 408), then a generic exception is tested (block 410) if one exists.

A generic exception may have an action defined for it. If a generic exception exists (“Yes” branch, block 410) and an action is defined for the generic exception (“Yes” branch, block 410), then the action is executed at block 416. If there is no generic exception (“No” branch, block 410) or if there is no action corresponding to a generic exception (“No” branch, block 412), then a generic exception message is generated at block 414 in accordance with block 314 and block 316 of FIG. 3.

Exemplary Computing Environment

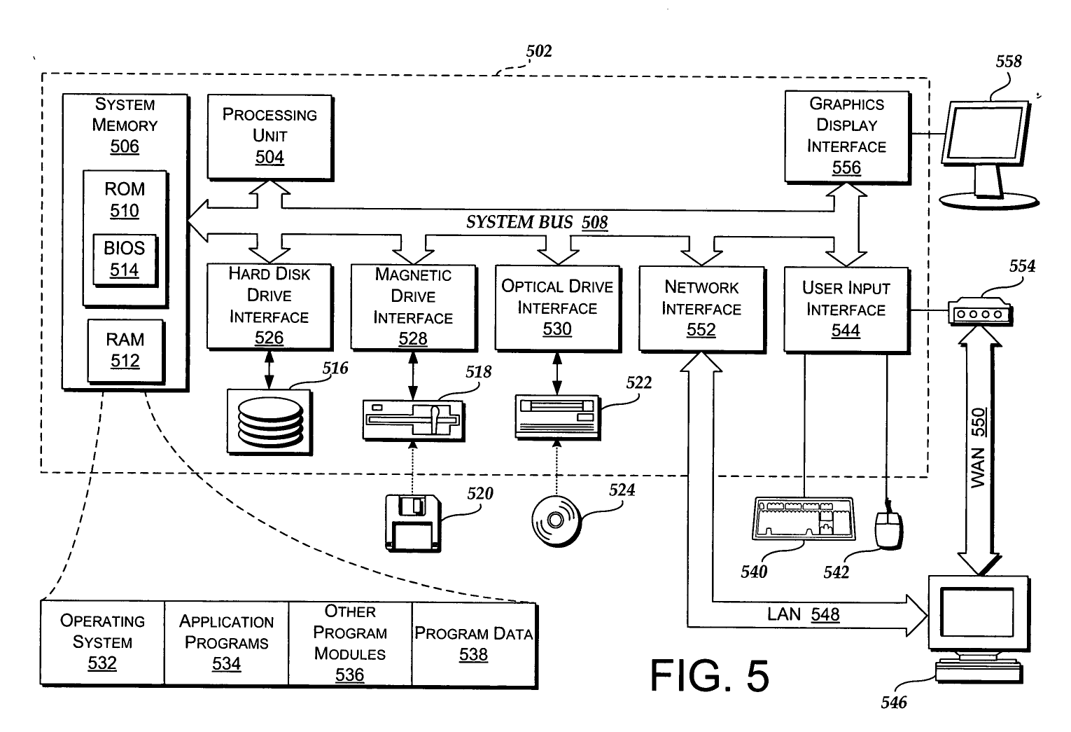

FIG. 5 illustrates an exemplary computing environment 500 within which user interface transition systems and methods, as well as the computing, network, and system architectures described herein, can be either fully or partially implemented. Exemplary computing environment 500 is only one example of a computing system and is not intended to suggest any limitation as to the scope of use or functionality of the architectures. Neither should the computing environment 500 be interpreted as having any dependency or requirement relating to any one or combination of components illustrated in the exemplary computing environment 500.

The computer and network architectures in computing environment 500 can be implemented with numerous other general purpose or special purpose computing system environments or configurations. Examples of well known computing systems, environments, and/or configurations that may be suitable for use include, but are not limited to, personal computers, server computers, client devices, hand-held or laptop devices, microprocessor-based systems, multiprocessor systems, set top boxes, programmable consumer electronics, network PCs, minicomputers, mainframe computers, gaming consoles, distributed computing environments that include any of the above systems or devices, and the like.

The computing environment 500 includes a general-purpose computing system in the form of a computing device 502. The components of computing device 502 can include, but are not limited to, one or more processors 504 (e.g., any of microprocessors, controllers, and the like), a system memory 506, and a system bus 508 that couples the various system components. The one or more processors 504 process various computer executable instructions to control the operation of computing device 502 and to communicate with other electronic and computing devices. The system bus 508 represents any number of several types of bus structures, including a memory bus or memory controller, a peripheral bus, an accelerated graphics port, and a processor or local bus using any of a variety of bus architectures.

Computing environment 500 includes a variety of computer readable media which can be any media that is accessible by computing device 502 and includes both volatile and non-volatile media, removable and non-removable media. The system memory 506 includes computer-readable media in the form of volatile memory, such as random access memory (RAM) 510, and/or non-volatile memory, such as read only memory (ROM) 512. A basic input/output system (BIOS) 514 maintains the basic routines that facilitate information transfer between components within computing device 502, such as during start-up, and is stored in ROM 512. RAM 510 typically contains data and/or program modules that are immediately accessible to and/or presently operated on by one or more of the processors 504.

Computing device 502 may include other removable/non-removable, volatile/non-volatile computer storage media. By way of example, a hard disk drive 516 reads from and writes to a non-removable, non-volatile magnetic media (not shown), a magnetic disk drive 518 reads from and writes to a removable, non-volatile magnetic disk 520 (e.g., a “floppy disk”), and an optical disk drive 522 reads from and/or writes to a removable, non-volatile optical disk 524 such as a CD-ROM, digital versatile disk (DVD), or any other type of optical media. In this example, the hard disk drive 516, magnetic disk drive 518, and optical disk drive 522 are each connected to the system bus 508 by one or more data media interfaces 526. The disk drives and associated computer readable media provide non-volatile storage of computer readable instructions, data structures, program modules, and other data for computing device 502.

Any number of program modules can be stored on the hard disk 516, magnetic disk 520, optical disk 524, ROM 512, and/or RAM 510, including by way of example, an operating system 526, one or more application programs 528, other program modules 530, and program data 532. Each of such operating system 526, application programs 528, other program modules 530, and program data 532 (or some combination thereof) may include an embodiment of the systems and methods described herein.

Computing device 502 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, other wireless media, and any combination thereof.

A user can interface with computing device 502 via any number of different input devices such as a keyboard 534 and pointing device 536 (e.g., a “mouse”). Other input devices 538 (not shown specifically) may include a microphone, joystick, game pad, controller, satellite dish, serial port, scanner, and/or the like. These and other input devices are connected to the processors 504 via input/output interfaces 540 that are coupled to the system bus 508, but may be connected by other interface and bus structures, such as a parallel port, game port, and/or a universal serial bus (USB).

A monitor 542 or other type of display device can be connected to the system bus 508 via an interface, such as a video adapter 544. In addition to the monitor 542, other output peripheral devices can include components such as speakers (not shown) and a printer 546 which can be connected to computing device 502 via the input/output interfaces 540.

Computing device 502 can operate in a networked environment using logical connections to one or more remote computers, such as a remote computing device 548. By way of example, the remote computing device 548 can be a personal computer, portable computer, a server, a router, a network computer, a peer device or other common network node, and the like. The remote computing device 548 is illustrated as a portable computer that can include many or all of the elements and features described herein relative to computing device 502.

Logical connections between computing device 502 and the remote computing device 548 are depicted as a local area network (LAN) 550 and a general wide area network (WAN) 552. Such networking environments are commonplace in offices, enterprise-wide computer networks, intranets, and the Internet. When implemented in a LAN networking environment, the computing device 502 is connected to a local network 550 via a network interface or adapter 554. When implemented in a WAN networking environment, the computing device 502 typically includes a modem 556 or other means for establishing communications over the wide area network 552. The modem 556, which can be internal or external to computing device 502, can be connected to the system bus 508 via the input/output interfaces 540 or other appropriate mechanisms. The illustrated network connections are exemplary and other means of establishing communication link(s) between the computing devices 502 and 548 can be utilized.

In a networked environment, such as that illustrated with computing environment 500, program modules depicted relative to the computing device 502, or portions thereof, may be stored in a remote memory storage device. By way of example, remote application programs 558 are maintained with a memory device of remote computing device 548. For purposes of illustration, application programs and other executable program components, such as the operating system 526, are illustrated herein as discrete blocks, although it is recognized that such programs and components reside at various times in different storage components of the computing device 502, and are executed by the processors 504 of the computing device.

### CONCLUSION

While one or more exemplary implementations have been illustrated and described, it will be appreciated that various changes can be made therein without departing from the spirit and scope of the claims appended hereto.

1. A method, comprising:
receiving a message having one or more properties;
copying the message properties to a process data structure;
executing one or more actions associated with the process data structure, said execution causing at least an addition or a modification of one or more process data structure properties;
generating a message having properties similar to the process data structure properties, including the at least one added or modified property; and
transmitting the message from the process data structure.

2. The method as recited in claim 1, wherein the process data structure further comprises a process definition data structure.

3. The method as recited in claim 1, wherein the process data structure further comprises a process instance data structure.

4. The method as recited in claim 1, further comprising correlating the message with the process data structure to identify the process data structure from a set of process data structures.

5. The method as recited in claim 1, wherein the process data structure does not include any external calls.

6. The method as recited in claim 1, further comprising:
determining if a process instance data structure exists that correlates to the received message;
if a process instance data structure exists, using the process instance data structure as the process data structure; and
if a process instance data structure does not exist, identifying a relevant process definition data structure and using the process definition data structure as the process data structure.

7. A workflow control system, comprising:
memory;
one or more process data structures stored in the memory, each of said process data structures including one or more actions;
a message queue configured to store at least one message having message properties associated therewith;
a process retrieval module configured to identify a process data structure that corresponds to a message from the message queue; and
a processor configured to execute at least one of the one or more actions contained in the identified process data structure; and
wherein the process data structure actions are configured such that execution of at least one action results in a property change in the process data structure.

8. The workflow control process as recited in claim 7, wherein the property change further comprises one of the following:
adding a new permanent property to the process data structure; or
permanently modifying an existing property of the process data structure.

9. The workflow processing system as recited in claim 7, wherein the process data structure actions are further configured such that execution of at least one action results in an addition of or modification to at least one action in the process data structure.

10. The workflow control system as recited in claim 7, wherein the one or more process data structure further comprises:
one or more process definition data structures; and
one or more process instance data structures, each process instance data structure being derived from a process definition data structure.

11. The workflow control system as recited in claim 10, wherein the process retrieval module is further configured to:
determine if the message correlates to one or more process instance data structures;
if the message correlates to one or more process instance data structures, identifying the one or more process instance data structures; and
if the message does not correlate to one or more process instance data structures, identifying a process definition data structure to be used to create a process instance data structure that corresponds to the message.

12. The workflow control system as recited in claim 7, wherein the actions are further configured to execute completely within a process defined by a process data structure without any external calls.

13. The workflow control system as recited in claim 7, wherein:
the message further comprises an inbound message; and
at least one action is further configured to create an outbound message having properties that reflect the property change.

14. The workflow control system as recited in claim 12, further comprising an input/output (IO) module configured to:
receive the message from a sending external application; and
transmit a message to a receiving external application.

15. The workflow control system as recited in claim 12, wherein:
the process data structure further comprises a first process data structure; and
the outbound message is queued in the message queue and is subsequently processed according to a second process data structure.

16. The workflow control system as recited in claim 12, further comprising an engine that is configured to:
select the inbound message from the message queue;
transmit the inbound message to the first process data structure;
queue the outbound message in the message queue; and
transmit the outbound message to the second data structure.

17. A process data structure stored on one or more computer-readable media, comprising:
one or more properties; and
one or more actions, at least one of which is configured to alter the one or more properties by adding a new property or modifying an existing property.

18. The process data structure as recited in claim 17, further comprising one or more correlators that can be used to match the process data structure with an incoming message.

19. The process data structure as recited in claim 17, wherein the actions are further configured to act entirely within the process data structure.

20. The process data structure as recited in claim 17, further comprising an action predicate associate with each action, and wherein an action is only executed if the action predicate is satisfied by comparisons between an incoming message and the process data structure properties.
